(19) United States
(12) Patent Application Publication
(10) Pub. No.: US 2025/0356666 A1
(43) Pub. Date: Nov. 20, 2025

(54) BURNED-IN CAPTION TEXT DETECTION

(71) Applicant: Beijing YoJaJa Software Technology Development Co., Ltd., Beijing (CN)

(72) Inventors: Shuai Lou, Beijing (CN); Monan Li, Beijing (CN); Kui Wang, Beijing (CN); Jun Sun, Beijing (CN); Gang Wang, Beijing (CN); Chao Zhang, Beijing (CN); Morgan Cheng, Beijing (CN)

(73) Assignee: Beijing YoJaJa Software Technology Development Co., Ltd., Beijing (CN)

(21) Appl. No.: 18/736,314

(22) Filed: Jun. 6, 2024

Related U.S. Application Data
(63) Continuation of application No. PCT/CN2024/093374, filed on May 15, 2024.

(51) Int. Cl. G06V 20/62; G06V 10/74; G06V 20/40; G06V 30/10

(52) U.S. Cl. CPC G06V 20/635; G06V 10/74; G06V 20/40; G06V 30/10

(57) ABSTRACT

In some embodiments, a method inputs a frame sample of a video into a prediction network of a discriminator. The frame sample is analyzed to determine whether the frame sample includes burned-in caption text. When the frame sample is determined to include burned-in caption text, the method sends the frame to a recognition engine to perform a recognition process on the frame sample, performs the recognition process on the frame sample to recognize text in the frame sample, and outputs the text for a service to be performed for the video. When the frame sample is determined to not include burned-in caption text, the method bypasses the recognition engine and does not perform the recognition process on the frame sample.

### CROSS REFERENCE TO RELATED APPLICATIONS

This application is a continuation application and, pursuant to 35 U.S.C. § 120, is entitled to and claims the benefit of earlier filed PCT application No. PCT/CN2024/093374, filed May 15, 2024, entitled “BURNED-IN CAPTION TEXT DETECTION”, the content of which is incorporated herein by reference in its entirety for all purposes.

### BACKGROUND

Burned-in caption text may be captions or subtitles that are encoded into the video frames of a video. Because the burned-in caption text is part of the encoded video frames, the burned-in caption text cannot be turned on and off. That is, the burned-in caption text will always be displayed when the video frame is displayed.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1 depicts an example of a video analysis system according to some embodiments.

FIG. 2 depicts a simplified flowchart of a method for sampling frames according to some embodiments.

FIG. 3A depicts an example of a frame that includes burned-in caption text according to some embodiments.

FIG. 3B depicts an example of non-caption text according to some embodiments.

FIG. 4 depicts a simplified flowchart of a method for performing the discriminator process according to some embodiments.

FIG. 5 depicts examples of frames that do not include burned-in caption text and frames that include burned-in caption text according to some embodiments.

FIG. 6 depicts a more detailed example of discriminator according to some embodiments.

FIG. 7 depicts an example of a training process of discriminator according to some embodiments.

FIG. 8 depicts a video streaming system in communication with multiple client devices via one or more communication networks according to one embodiment.

FIG. 9 depicts a diagrammatic view of an apparatus for viewing video content and supplemental content.

### DETAILED DESCRIPTION

Described herein are techniques for a video analysis system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A text recognition process may recognize burned-in caption text. A system processes video frames of a video to improve the text recognition process for text. For example, the system includes a discriminator that analyzes frames to distinguish between frames that include burned-in caption text and frames that do not include burned-in caption text. The term “burned-in” indicates that the text is encoded in the frame so the text cannot be turned off by a viewer (e.g., removed from display). The term “caption” indicates the functionality of the text. In some embodiments, the term caption may be either closed captions or subtitles. A closed caption provides the textual transcript of a video's dialogue. It is designed for use by hard of hearing audiences. Subtitles provide a textual translation of the video dialogue. The subtitles may assume the viewer can hear the audio but cannot understand the language. Both of closed captions and subtitles are timed text which reflects the content of the video's dialogue. Burned-in caption text may be text that is “burned” into an image of a frame and embedded in the frame. The burned-in caption text is encoded into the video frames of a video. The burned-in caption text may be added to the video frames before encoding, but was not captured by a camera or included in the captured video. Non-caption text may be text that has been “burned” into the image of the frame or embedded. Also, non-caption text may not be generated based on timed text which reflects the content of the video's dialogue. The non-caption text may be present in the frames for different reasons. For example, the non-caption text may have been captured by a camera in the video (e.g., in signs, labels, etc.). Also, non-caption text may have been added to frames, but is not related to captions or subtitles for audio being spoken in the video (e.g., a news ticker). Other examples of non-caption text may be a stock ticker at the bottom of the frame or a headline for a news story, an advertisement in a soccer game on a wall, etc.

The discriminator may include a prediction network that is specially trained to recognize burned-in caption text and distinguish between burned-in caption text and non-caption text. The discriminator may send frames that are determined to include burned-in caption text to a text recognition process, such as an optical character recognition (OCR), and bypass the text recognition process (e.g., OCR) for frames that are determined to not include burned-in caption text. The prediction network is specially trained to distinguish between burned-in caption text and non-caption text such that frames with non-caption text may not be selected as including burned-in caption text.

The OCR engine may use a text recognition process to recognize text. The text recognition process may use different processes, such as optical character recognition, intelligent character recognition, etc. Optical character recognition analyzes the shapes and patterns to identify and recognize the characters in an image. Once the text is recognized, a service may be performed, such as a text service may recognize the language of the text. Recognizing the language of the text may allow a video delivery system to perform services, such as translating the burned-in caption text to other languages.

The system provides many improvements. One difficulty may be recognizing subtle differences between burned-in caption text and non-caption text. The non-caption text may be added to video frames in the case of a news ticker. However, this is not considered burned-in caption text by the system because the news ticker is an overlay over the frames of the video or not captions or subtitles of audio. Using the discriminator may decrease the recognition of non-caption text by the OCR engine. By discriminating between frames that include burned-in caption text and frames that do not include burned-in caption text or include non-caption text, the optical character recognition process is improved. For example, the recognition by the OCR engine of text from non-caption text is reduced. Also, the OCR recognition process is a resource-heavy process. By limiting the number of frames and refining the input into the OCR, computing resources of the optical character recognition process is saved and performance of the optical character recognition process is improved. The functionality and performance of the optical character recognition process is also improved when recognizing burned-in text. Further, using the OCR engine to determine whether there is burned-in caption text or non-caption text in place of the discriminator may use more computing resources compared to using the trained prediction network as described herein. Also, the detection of burned-in caption text may have been performed manually before. For example, previously, the video needed to be viewed by a user and the burned-in caption text needed to be identified manually. This required the video to be viewed at a playback speed. Using the system, the burned-in caption text can be automatically determined and recognized quicker than playing back the video or portions of the video, and the service can be performed earlier. When videos need to be published on a video delivery system with a deadline, the use of the system to detect burned-in text is useful.

### System

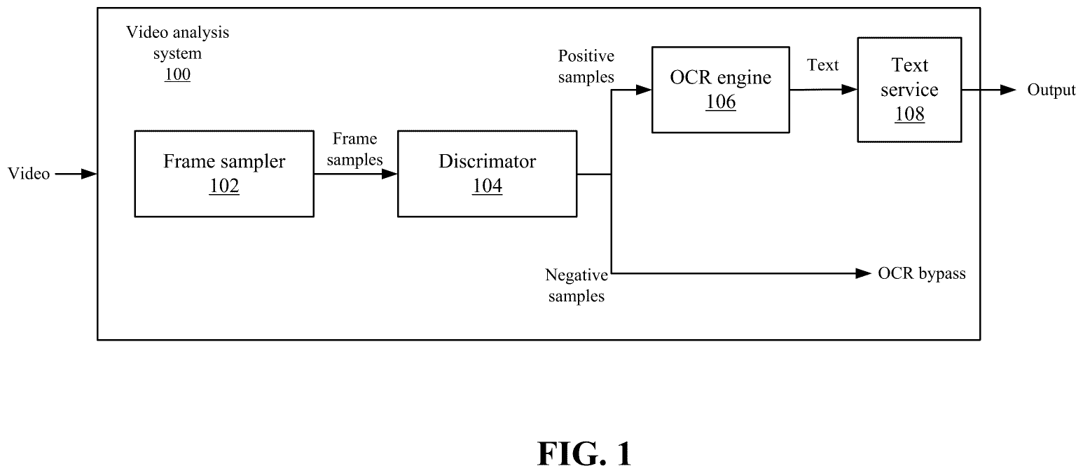

FIG. 1 depicts an example of a video analysis system 100 according to some embodiments. Video analysis system 100 includes one or more computing devices that can perform the processes described herein. Video analysis system 100 includes a frame sampler 102, a discriminator 104, an optical character recognition (OCR) engine 106, and a text service 108.

Video analysis system 100 receives frames, which may be images. The frames may be from a video or videos. Although a video is discussed, other types of content may be received, such as a series of frames or images that may not be included in a video.

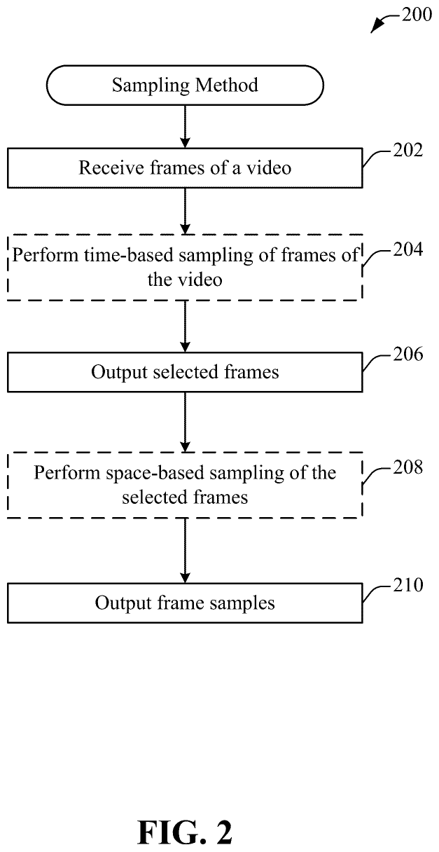

Frame sampler 102 may receive the frames, analyze the frames, and output frame samples. The frame samples may be frames that will be analyzed by discriminator 104. In some embodiments, frame sampler 102 may select less than all of the frames that are received, such as less than all of the frames in a video are selected. However, frame sampler 102 may select all of the frames in the video. Also, portions of frames may be selected, such as only a bottom portion of the frame. In some embodiments, frame sampler 102 may perform different processes to select frames as frame samples, such as a time-based frame sampling and a space-wise frame sampling. FIG. 2 will describe the time-based sampling and space-wise sampling in more detail.

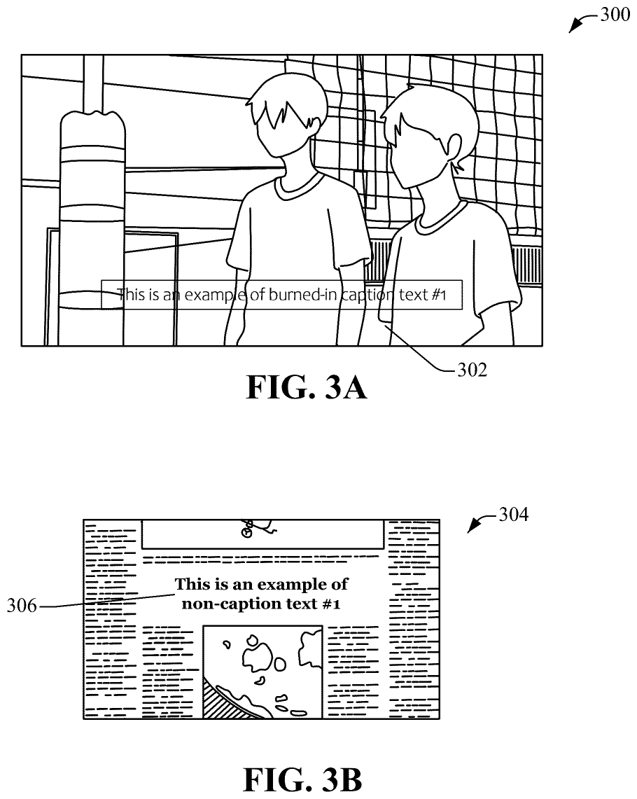

Discriminator 104 may distinguish between frames that include burned-in caption text and frames that do not include burned-in caption text. For example, discriminator 104 includes a prediction network that is trained to recognize frames with burned-in caption text in contrast to frames that do not include burned-in caption text or frames that include non-caption text without burned-in caption text. The process of recognizing frames with burned-in caption text will be described in more detail starting in FIG. 3. Discriminator 104 outputs positive samples and negative samples. Positive samples may be frame samples that are determined to include burned-in caption text and negative samples are frame samples that are determined to not include burned-in caption text. The negative samples bypass the OCR process. The positive samples are input into OCR engine 106.

OCR Engine 106 may recognize the text found in the frame. For example, OCR engine 106 may recognize burned-in caption text. In some examples, if the burned-in caption text is, “She's happy this time”, OCR engine may recognize this text as output.

OCR engine 106 outputs the text that is recognized in the frame. For example, OCR engine 106 may output “She's happy this time”. Text service 108 may perform different services. In some embodiments, text service 108 may determine the language of the text. In the above example, text service 108 determines that the language of the text is English. Text service 108 then outputs the language, such as the language of “English”. Text service 108 may also perform other services, such as text service 108 may remove the burned-in caption text from the frame.

A video delivery system may want to know the language of the burned-in caption text for different reasons. For example, the video delivery system may want to translate the burned-in caption text to other languages. By knowing the language of the burned-in caption text, the translation can be performed, such as from English to Spanish.

Accordingly, video analysis system 100 uses less computing resources by analyzing the positive samples at OCR engine 106. Also, the process is improved because the recognition of text by OCR engine 106 more accurately recognized burned-in caption text and reduces the chances of false positives of recognizing non-caption text.

### Frame Sampler

FIG. 2 depicts a simplified flowchart 200 of a method for sampling frames according to some embodiments. At 202, frame sampler 102 receives frames of a video. For example, each frame of the video may be received for analysis.

In the following, time-based sampling and space-based sampling are discussed. Either process may be optional. For example, time-based sampling and space-based sampling may be performed, only time-based sampling may be performed, only space-based sampling may be performed, or neither may be performed. The time-based sampling and the space-based sampling may be performed in either order.

At 204, frame sampler 102 may perform time-based sampling of frames of the video. Time-based sampling may sample frames from a timeline of the video. Different strategies for time-based sampling may be used, such as an interval sampling timeline process, or sampling of frames in which audio occurs. Sampling in an interval may sample frames based on an interval, such as every other frame, every five frames, every 10 frames, etc. Also, the interval does not need to be uniform, such as the first 15 frames, some interval of frames, and the last 15 frames may be selected. The sampling may be performed based on the frame identifier or time in the video, such as frame #1, #3, etc., or frames around 1 second, 3 seconds, etc.

In other embodiments, frame sampler 102 may only sample frames in which a voice (e.g., human, animated character, machine, etc.) is detected on the audio track. For example, burned-in caption text may most likely occur when a voice is found in the audio track. This may be because the burned-in caption text may be a subtitle or caption for the voice. This may occur in certain types of videos, such as anime. Frame sampler 102 may analyze the audio track, and when a voice is detected, frame sampler 102 determines a corresponding frame identifier and selects the respective frame. In some embodiments, if a number of frames with voice present is less than the number of frames for the time-based sampling, then this process may be more efficient and select less frames. Also, selecting frames based on the audio track may select frames more likely to include burned-in caption text and not select frames that may be less likely to include burned-in caption text.

At 206, frame sampler 102 outputs the selected frames. For example, the selected frames may be every 5th frame from the time-based sampling or frames in which audio was detected.

At 208, frame sampler 102 may perform space-based sampling of the selected frames. The space-based sampling process may select a portion of the frame, such as an area within the frame, as the final output. For example, for burned-in caption text, the frames may typically show the burned-in caption text in an area of the frame, such as a bottom part of the frame. Frame sampler 102 may select this area as the output, which may lower the possibility of including non-caption text in the sample. For example, the background of the frame may include non-caption text, which may be eliminated by selecting the bottom portion of the frame, and not the top portion. However, the full frame may also be used.

At 210, frame sampler 102 outputs the frame samples. These frame samples are analyzed by discriminator 104.

FIG. 3A depicts an example of a frame 300 that includes burned-in caption text according to some embodiments. At 302, the burned-in caption text of “This is burned-in caption text #1” is shown to indicate there is burned-in caption text here of an audio track.

FIG. 3B depicts an example 304 of non-caption text according to some embodiments. At 306, a banner in the frame includes a news headline. The text of “This is an example of non-caption text #1” is shown to indicate there is non-caption text here.

### Discriminator

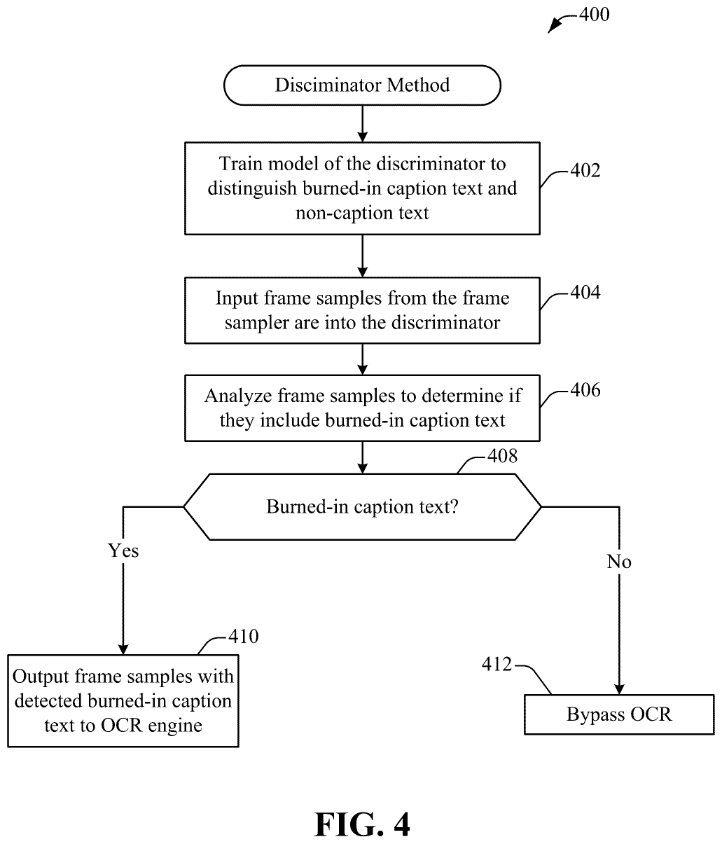

FIG. 4 depicts a simplified flowchart 400 of a method for performing the discriminator process according to some embodiments. At 402, a model of a prediction network for discriminator 104 is trained to recognize burned-in caption text, and also may be trained to distinguish between burned-in caption text and non-caption text. The model may be trained by using examples of non-caption text and burned-in caption text as training samples. The parameters of the model may be adjusted or tuned to recognize burned-in caption text and non-caption text. For example, when a sample with burned-in caption text is input into the model, parameters of the model are adjusted such that the prediction network determines this text is burned-in caption text. Also, when non-caption text samples are input into the prediction network, the parameters of the model are adjusted such that the prediction network determines that this sample includes non-caption text. Also, when no text samples are input into the prediction network, the parameters of the model are adjusted such that the prediction network determines that this sample includes no text.

At 404, the frame samples from frame sampler 102 are input into discriminator 104. As discussed above, not all frames of the video may be input into discriminator 104 if time-based frame sampling was performed, but all the frames may be input. Also, the frame samples may be portions of the original frames if space-based sampling was performed.

At 406, discriminator 104 analyzes the frame samples to determine if they include burned-in caption text. In some embodiments, the prediction network may receive the frame sample as input, and output a score that indicates whether burned-in caption text is found in the frame sample. In other embodiments, the output of the prediction network may be a first value that indicates the frame includes burned-in caption text and a second value that indicates the frame does not include burned-in caption text. Also, the prediction network may indicate that the frame includes both burned-in caption text and non-caption text. Or, the prediction network may indicate the frame does not include any text at all. The analysis using discriminator 104 may be less resource intensive compared to using an optical character recognition process. For example, the optical character recognition process may require more computing resources to recognize the existence of text and then recognize every character of the text in the frame. In contrast, the prediction network may analyze the pixels of the frame samples and output a prediction in a less resource intensive method to identify the existence of burned-in text.

At 408, discriminator 104 determines if the frame samples include burned-in caption text. In some embodiments, if the prediction network outputted one score that may be the probability of including burned-in caption, discriminator 104 may compare the score to a threshold to determine whether or not the frame includes burned-in caption text. Scores that meet a threshold (e.g., a probability higher than the threshold) may indicate the frame includes burned-in caption text. In other embodiments, the score is a binary score where the output of the prediction network is a first value that indicates the frame includes burned-in caption text or a second value that indicates the frame does not include burned-in caption text. Also, if the prediction network outputted multiple scores, discriminator 104 determines whether a first score meets a threshold (e.g., a probability higher than the threshold) that may indicate the frame includes burned-in caption text. Also, discriminator 104 determines whether a second score meets a threshold (e.g., a probability higher than the threshold) that may indicate the frame does not include burned-in caption text.

If the frame samples include burned-in caption text, at 410, discriminator 104 outputs the frame samples with detected burned-in caption text to OCR engine 106. If the frame samples do not include burned-in caption text, at 412, discriminator 104 bypasses the OCR process for these frames. That is, these frame samples are not input into OCR engine 106. This saves computing resources as these frames are not analyzed by OCR engine 106.

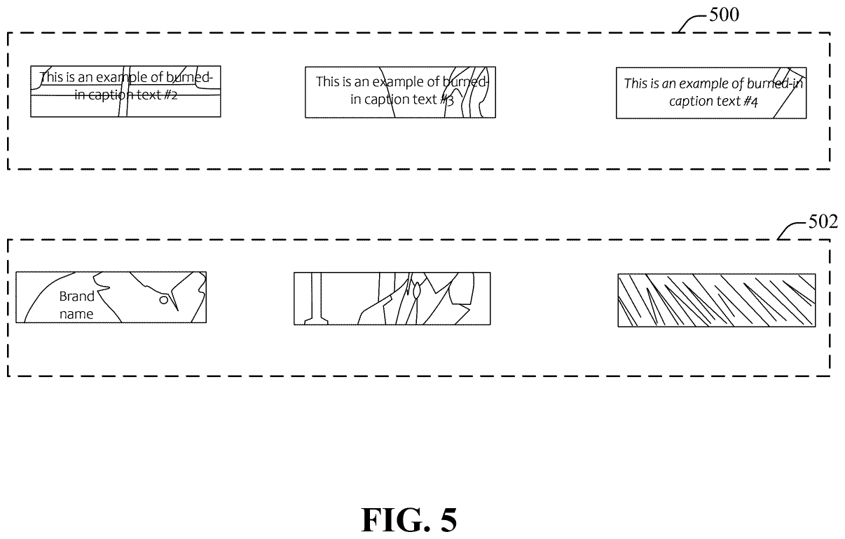

FIG. 5 depicts examples of frames that do not include burned-in caption text and frames that include burned-in caption text according to some embodiments. At 500, examples are shown with burned-in caption text. In these cases, text is shown that corresponds to audio being spoken in the video. At 502, samples without burned-in caption text are shown. Non-caption text may be shown in these samples, such as the text “Brand name” is shown of a brand of a suit. However, no text may be shown on these samples.

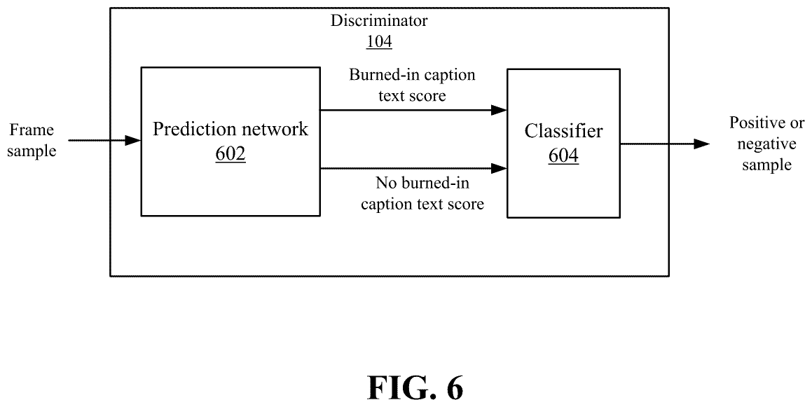

FIG. 6 depicts a more detailed example of discriminator 104 according to some embodiments. Although this structure of discriminator 104 is described, other structures may be appreciated. A prediction network 602 receives a frame sample as input. The frame sample may be received from frame sampler 102. Prediction network 602 analyzes pixels of the frame sample to determine whether the frame sample includes burned-in caption text or not. In some embodiments, prediction network 602 includes two outputs of a first output for a score of a probability that the frame includes burned-in caption text and a second output for a probability that the frame does not include burned-in caption text. The probability is based on analyzing patterns in the frame to detect burned-in caption text. For example, edges in the frame may be analyzed for patterns that are similar to examples of burned-in caption text.

The scores may be analyzed to determine whether to select the frame as a positive sample or negative sample. For example, if the burned-in caption text score meets a threshold, then a classifier 604 determines the frame is a positive sample. Also, if the score that the frame does not include burned-in caption text meets a threshold, classifier 604 determines the frame is a negative sample. If both thresholds are not met, classifier 604 may determine that the frame is a positive sample or a negative sample depending on a configuration setting. For example, classifier 604 may select frames that do not meet the two thresholds as negative samples.

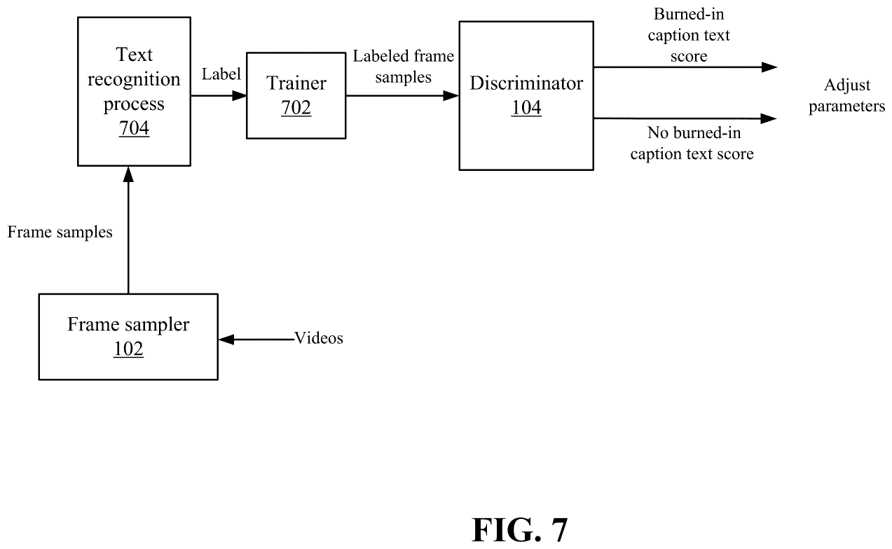

FIG. 7 depicts an example of a training process of discriminator 104 according to some embodiments. Frame sampler 102 may receive videos, such as from a video library. Frame sampler 102 outputs frame samples to a text recognition process 704. Text recognition process 704 may recognize text in the frame samples and output a label. The label may be the text that is found in the frame samples, and whether the frame includes burned-in caption text non-caption text. Other methods to generate the label may also be used, such as using a pre-labeled dataset.

A trainer 702 may train discriminator 104. In some examples, trainer 702 may label frame samples with burned-in caption text and frame samples that do not include burned-in caption text. Frame samples are input into discriminator 104. Discriminator 104 outputs a burned-in text score and a does not include burned-in caption text score. Depending on whether the frame sample was labeled with a frame that includes burned-in caption text or includes non-caption text, trainer 702 adjusts the parameters. For example, if the frame includes burned-in caption text, then trainer 702 adjusts the parameters of discriminator 104 to output a higher score for the first output of burned-in caption text score and a lower score for the second output of that the text does not include burned-in caption text. If the frame includes non-caption text, then trainer 702 adjusts the parameters of discriminator 104 to output a lower score for the first output of burned-in caption text score and a higher score for the second output of that the text does not include burned-in caption text. The parameters are adjusted such that discriminator 104 is trained to distinguish between burned-in caption text and non-caption text. After training, discriminator 104 is configured to distinguish between burned-in caption text and non-caption text because discriminator 104 will be able to recognize that non-caption text is not burned-in caption text.

### OCR and Text Service

OCR engine 106 then analyzes the frame samples that are input and recognizes the text in the frame samples. Different methods of performing optical character recognition may be used. The output of OCR engine 106 is text that is recognized.

Text service 108 then performs a service on the text that is recognized. In some embodiments, when a language is being determined, multiple samples of the text that are recognized from a video are analyzed. Then, text service 108 may make a final decision based on the samples that are analyzed. For example, a prediction network may output a classification for the language or a probability. Also, if the number of samples of text in a language, such as the English language, meet a threshold (e.g., 95%), text service 108 outputs an indication that the English language is being used for the burned-in captions. However, if the number of samples do not meet a threshold for a language, that language is not picked. Text service 108 may output the language that is selected. Or, if multiple languages are detected, text service 108 outputs different languages for different samples. Then, the language can be used to perform another service, such as translating the text from the language into other languages. Text service 108 can generate caption files from burned-in captions so that the new captions can be used by the other versions of the same video without burned-in captions. Also, the language may be used as metadata to indicate which language is burned-in the video. The metadata may be used by other services, such as a service that determines if a video can be launched in a region that supports the language.

### Conclusion

Accordingly, video analysis system 100 improves upon the detection of burned-in caption text. Also, the analysis may be performed without any human intervention. The process saves computing resources that are used to determine whether frames include burned-in caption text. Also, the process improves the detection process by processing video frames for input into an OCR engine 106. This may reduce the false positives where OCR engine 106 misrecognizes non-caption text as burned-in caption text.

### System

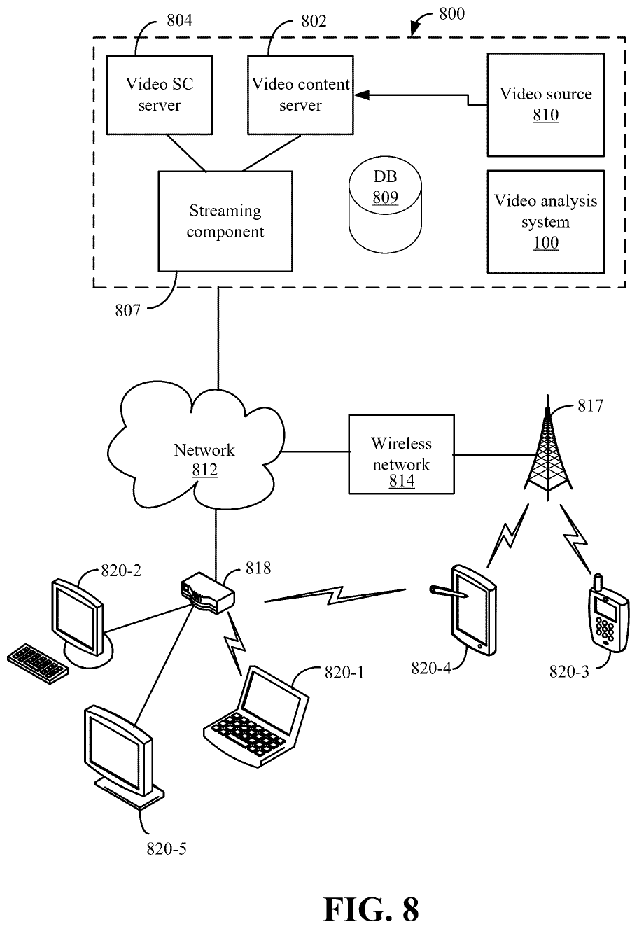

Features and aspects as disclosed herein may be implemented in conjunction with a video streaming system 800 in communication with multiple client devices via one or more communication networks as shown in FIG. 8. Aspects of the video streaming system 800 are described merely to provide an example of an application for enabling distribution and delivery of content prepared according to the present disclosure. It should be appreciated that the present technology is not limited to streaming video applications and may be adapted for other applications and delivery mechanisms.

In one embodiment, a media program provider may include a library of media programs. For example, the media programs may be aggregated and provided through a site (e.g., website), application, or browser. A user can access the media program provider's site or application and request media programs. The user may be limited to requesting only media programs offered by the media program provider.

In system 800, video data may be obtained from one or more sources for example, from a video source 810, for use as input to a video content server 802. The input video data may comprise raw or edited frame-based video data in any suitable digital format, for example, Moving Pictures Experts Group (MPEG)-1, MPEG-2, MPEG-4, VC-1, H.264/Advanced Video Coding (AVC), High Efficiency Video Coding (HEVC), or other format. In an alternative, a video may be provided in a non-digital format and converted to digital format using a scanner or transcoder. The input video data may comprise video clips or programs of various types, for example, television episodes, motion pictures, and other content produced as primary content of interest to consumers. The video data may also include audio or only audio may be used.

The video streaming system 800 may include one or more computer servers or modules 802, 804, and 807 distributed over one or more computers. Each server 802, 804, 807 may include, or may be operatively coupled to, one or more data stores 809, for example databases, indexes, files, or other data structures. A video content server 802 may access a data store (not shown) of various video segments. The video content server 802 may serve the video segments as directed by a user interface controller communicating with a client device. As used herein, a video segment refers to a definite portion of frame-based video data, such as may be used in a streaming video session to view a television episode, motion picture, recorded live performance, or other video content.

In some embodiments, a video supplemental content (SC) server 804 may access a data store of relatively short videos (e.g., 10 second, 30 second, or 60 second supplemental content) configured as advertising for a particular advertiser or message. The supplemental content may be provided for an entity in exchange for payment of some kind or may comprise a promotional message for the system 800, a public service message, or some other information. The video supplemental content server 804 may serve the supplemental content segments as directed by a user interface controller (not shown).

The video streaming system 800 also may include video analysis system 100.

The video streaming system 800 may further include an integration and streaming component 807 that integrates video content and supplemental content into a streaming video segment. For example, streaming component 807 may be a content server or streaming media server. A controller (not shown) may determine the selection or configuration of supplemental content in the streaming video based on any suitable algorithm or process. The video streaming system 800 may include other modules or units not depicted in FIG. 8, for example, administrative servers, commerce servers, network infrastructure, supplemental content selection engines, and so forth.

The video streaming system 800 may connect to a data communication network 812. A data communication network 812 may comprise a local area network (LAN), a wide area network (WAN), for example, the Internet, a telephone network, a wireless network 814 (e.g., a wireless cellular telecommunications network (WCS)), or some combination of these or similar networks.

One or more client devices 820 may be in communication with the video streaming system 800, via the data communication network 812, wireless network 814, or another network. Such client devices may include, for example, one or more laptop computers 820-1, desktop computers 820-2, “smart” mobile phones 820-3, tablet devices 820-4, network-enabled televisions 820-5, or combinations thereof, via a router 818 for a LAN, via a base station 817 for wireless network 814, or via some other connection. In operation, such client devices 820 may send and receive data or instructions to the system 800, in response to user input received from user input devices or other input. In response, the system 800 may serve video segments and metadata from the data store 809 responsive to selection of media programs to the client devices 820. Client devices 820 may output the video content from the streaming video segment in a media player using a display screen, projector, or other video output device, and receive user input for interacting with the video content.

Distribution of audio-video data may be implemented from streaming component 807 to remote client devices over computer networks, telecommunications networks, and combinations of such networks, using various methods, for example streaming. In streaming, a content server streams audio-video data continuously to a media player component operating at least partly on the client device, which may play the audio-video data concurrently with receiving the streaming data from the server. Although streaming is discussed, other methods of delivery may be used. The media player component may initiate play of the video data immediately after receiving an initial portion of the data from the content provider. Traditional streaming techniques use a single provider delivering a stream of data to a set of end users. High bandwidth and processing power may be required to deliver a single stream to a large audience, and the required bandwidth of the provider may increase as the number of end users increases.

Streaming media can be delivered on-demand or live. Streaming enables immediate playback at any point within the file. End-users may skip through the media file to start playback or change playback to any point in the media file. Hence, the end-user does not need to wait for the file to progressively download. Typically, streaming media is delivered from a few dedicated servers having high bandwidth capabilities via a specialized device that accepts requests for video files, and with information about the format, bandwidth, and structure of those files, delivers just the amount of data necessary to play the video, at the rate needed to play it. Streaming media servers may also account for the transmission bandwidth and capabilities of the media player on the destination client. Streaming component 807 may communicate with client device 820 using control messages and data messages to adjust to changing network conditions as the video is played. These control messages can include commands for enabling control functions such as fast forward, fast reverse, pausing, or seeking to a particular part of the file at the client.

Since streaming component 807 transmits video data only as needed and at the rate that is needed, precise control over the number of streams served can be maintained. The viewer will not be able to view high data rate videos over a lower data rate transmission medium. However, streaming media servers (1) provide users random access to the video file, (2) allow monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming component 807 may use TCP-based protocols, such as HyperText Transfer Protocol (HTTP) and Real Time Messaging Protocol (RTMP). Streaming component 807 can also deliver live webcasts and can multicast, which allows more than one client to tune into a single stream, thus saving bandwidth. Streaming media players may not rely on buffering the whole video to provide random access to any point in the media program. Instead, this is accomplished using control messages transmitted from the media player to the streaming media server. Other protocols used for streaming are HTTP live streaming (HLS) or Dynamic Adaptive Streaming over HTTP (DASH). The HLS and DASH protocols deliver video over HTTP via a playlist of small segments that are made available in a variety of bitrates typically from one or more content delivery networks (CDNs). This allows a media player to switch both bitrates and content sources on a segment-by-segment basis. The switching helps compensate for network bandwidth variances and infrastructure failures that may occur during playback of the video.

The delivery of video content by streaming may be accomplished under a variety of models. In one model, the user pays for the viewing of video programs, for example, paying a fee for access to the library of media programs or a portion of restricted media programs, or using a pay-per-view service. In another model widely adopted by broadcast television shortly after its inception, sponsors pay for the presentation of the media program in exchange for the right to present supplemental content during or adjacent to the presentation of the program. In some models, supplemental content is inserted at predetermined times in a video program, which times may be referred to as “slots” or “breaks.” With streaming video, the media player may be configured so that the client device cannot play the video without also playing predetermined supplemental content during the designated slots.

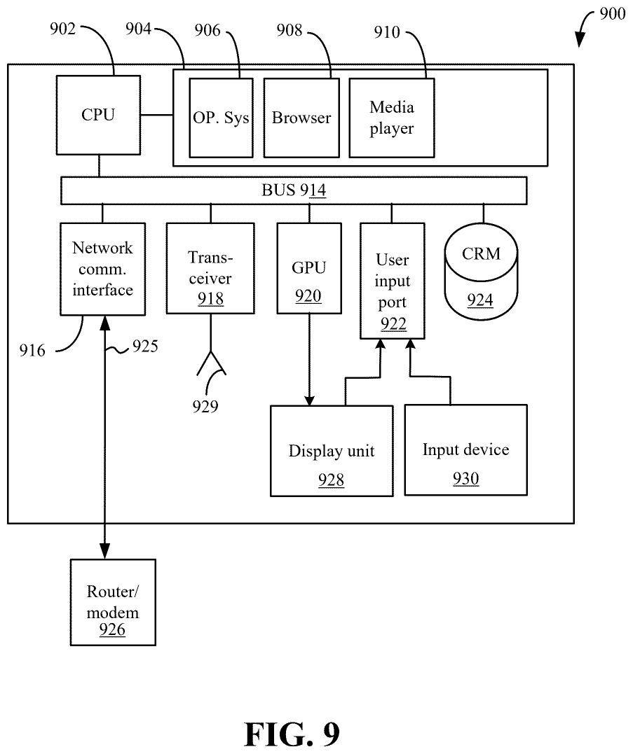

Referring to FIG. 9, a diagrammatic view of an apparatus 900 for viewing video content and supplemental content is illustrated. In selected embodiments, the apparatus 900 may include a processor (CPU) 902 operatively coupled to a processor memory 904, which holds binary-coded functional modules for execution by the processor 902. Such functional modules may include an operating system 906 for handling system functions such as input/output and memory access, a browser 908 to display web pages, and media player 910 for playing video. The memory 904 may hold additional modules not shown in FIG. 9, for example modules for performing other operations described elsewhere herein.

A bus 914 or other communication components may support communication of information within the apparatus 900. The processor 902 may be a specialized or dedicated microprocessor configured or operable to perform particular tasks in accordance with the features and aspects disclosed herein by executing machine-readable software code defining the particular tasks. Processor memory 904 (e.g., random access memory (RAM) or other dynamic storage device) may be connected to the bus 914 or directly to the processor 902, and store information and instructions to be executed by a processor 902. The memory 904 may also store temporary variables or other intermediate information during execution of such instructions.

A computer-readable medium in a storage device 924 may be connected to the bus 914 and store static information and instructions for the processor 902; for example, the storage device (CRM) 924 may store the modules for operating system 906, browser 908, and media player 910 when the apparatus 900 is powered off, from which the modules may be loaded into the processor memory 904 when the apparatus 900 is powered up. The storage device 924 may include a non-transitory computer-readable storage medium holding information, instructions, or some combination thereof, for example instructions that when executed by the processor 902, cause the apparatus 900 to be configured or operable to perform one or more operations of a method as described herein.

A network communication (comm.) interface 916 may also be connected to the bus 914. The network communication interface 916 may provide or support two-way data communication between the apparatus 900 and one or more external devices, e.g., the streaming system 800, optionally via a router/modem 926 and a wired or wireless connection 925. In the alternative, or in addition, the apparatus 900 may include a transceiver 918 connected to an antenna 929, through which the apparatus 900 may communicate wirelessly with a base station for a wireless communication system or with the router/modem 926. In the alternative, the apparatus 900 may communicate with a video streaming system 800 via a local area network, virtual private network, or other network. In another alternative, the apparatus 900 may be incorporated as a module or component of the system 800 and communicate with other components via the bus 914 or by some other modality.

The apparatus 900 may be connected (e.g., via the bus 914 and graphics processing unit 920) to a display unit 928. A display 928 may include any suitable configuration for displaying information to an operator of the apparatus 900. For example, a display 928 may include or utilize a liquid crystal display (LCD), touchscreen LCD (e.g., capacitive display), light emitting diode (LED) display, projector, or other display device to present information to a user of the apparatus 900 in a visual display.

One or more input devices 930 (e.g., an alphanumeric keyboard, microphone, keypad, remote controller, game controller, camera, or camera array) may be connected to the bus 914 via a user input port 922 to communicate information and commands to the apparatus 900. In selected embodiments, an input device 930 may provide or support control over the positioning of a cursor. Such a cursor control device, also called a pointing device, may be configured as a mouse, a trackball, a track pad, touch screen, cursor direction keys or other device for receiving or tracking physical movement and translating the movement into electrical signals indicating cursor movement. The cursor control device may be incorporated into the display unit 928, for example using a touch sensitive screen. A cursor control device may communicate direction information and command selections to the processor 902 and control cursor movement on the display 928. A cursor control device may have two or more degrees of freedom, for example allowing the device to specify cursor positions in a plane or three-dimensional space.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
inputting a frame sample of a video into a prediction network of a discriminator;
analyzing the frame sample to determine whether the frame sample includes burned-in caption text;
when the frame sample is determined to include burned-in caption text:
sending the frame to a recognition engine to perform a recognition process on the frame sample;
performing the recognition process on the frame sample to recognize text in the frame sample;
outputting the text for a service to be performed for the video; and
when the frame sample is determined to not include burned-in caption text, bypassing the recognition engine and not performing the recognition process on the frame sample.

2. The method of claim 1, wherein when the frame includes non-caption text, the prediction network determines the frame sample does not include burned-in caption text.

3. The method of claim 1, further comprising:
receiving frames of the video; and
analyzing the frames of the video to select a first portion of the frames for input into the prediction network, wherein a second portion of the frames is not input into the prediction network or the recognition engine.

4. The method of claim 3, wherein the first portion of the frames is selected based on a time-based sampling that selects frames based on a time associated with the frames.

5. The method of claim 1, further comprising:
receiving the frame of the video; and
selecting a first portion of the frame for input into the prediction network, wherein a second portion of the frame is not input into the prediction network or the recognition engine.

6. The method of claim 5, wherein the first portion of frame is selected based on an area that is designated as likely to include burned-in caption text.

7. The method of claim 1, wherein the burned-in caption text is inserted in the frame before encoding of the frame.

8. The method of claim 1, wherein:
determining whether the frame include burned-in caption text comprises not recognizing non-caption text as burned-in caption text, and
the non-caption text is inserted in the frame after encoding of the frame or captured by a camera.

9. The method of claim 1, further comprising:
training the prediction network to recognize patterns in frames for burned-in caption text, wherein parameters for the prediction network are adjusted to distinguish between burned-in caption text and non-caption text.

10. The method of claim 9, further comprising:
training the prediction network to recognize patterns in frames for non-caption text, wherein parameters for the prediction network are adjusted to distinguish between burned-in caption text and non-caption text.

11. The method of claim 1, wherein training the prediction network comprises:
labeling training frames with a label that the frame includes burned-in caption text or does not include burned-in caption text;
analyzing the frames with the prediction network to output a score of whether the frames include burned-in caption text; and
adjusting parameters of the prediction network based on a comparison of labels of the frames and the respective score for the frames.

12. The method of claim 1, wherein analyzing the frame sample comprises:
analyzing pixels of the frame to determine a score of a probability that the frame includes burned-in caption text; and
comparing the score to a threshold to determine whether to select the frame for input into the recognition engine.

13. The method of claim 1, wherein analyzing the frame sample comprises:
analyzing pixels of the frame to determine a first score of a probability that the frame includes burned-in caption text;
analyzing pixels of the frame to determine a second score of a probability that the frame does not include burned-in caption text;
comparing the first score to a first threshold to determine whether to select the frame for input into the recognition engine; and
comparing the second score to a second threshold to determine whether to select the frame for bypass of the recognition engine.

14. The method of claim 1, wherein analyzing the frame sample comprises:
when the frame sample is determined to include non-caption text, bypassing the recognition engine.

15. The method of claim 1, further comprising:
analyzing the text to determine a language of the text; and
performing a service for the video based on the language.

16. The method of claim 1, wherein performing the service comprises:
translating the text to another language.

17. A non-transitory computer-readable storage medium having stored thereon computer executable instructions, which when executed by a computing device, cause the computing device to be operable for:
inputting a frame sample of a video into a prediction network of a discriminator;
analyzing the frame sample to determine whether the frame sample includes burned-in caption text;
when the frame sample is determined to include burned-in caption text:
sending the frame to a recognition engine to perform a recognition process on the frame sample;
performing the recognition process on the frame sample to recognize text in the frame sample;
outputting the text for a service to be performed for the video; and
when the frame sample is determined to not include burned-in caption text, bypassing the recognition engine and not performing the recognition process on the frame sample.

18. A method comprising:
inputting frame samples of a video into a prediction network of a discriminator to generate a score for whether the frame samples include burned-in caption text;
training the prediction network to recognize patterns in frames for burned-in caption text;
adjusting parameters for the prediction network to adjust the score for frames with burned-in caption text to indicate respective frames include burned-in caption text;
training the prediction network to recognize patterns in frames for non-caption text; and
adjusting parameters for the prediction network to adjust the score for frames with non-caption text to indicate respective frames do not include burned-in caption text, wherein prediction network is trained to output a score a frame sample that includes non-caption text does not include burned-in caption text.

19. The method of claim 18, further operable to:
using the prediction network to determine whether a frame sample includes burned-in caption text or does not include burned-in caption text.

20. The method of claim 18, wherein:
the prediction network outputs a score that indicates the frame sample includes burned-in caption text when the frame sample includes burned-in caption text, and
the prediction network outputs a score that indicates the frame sample does not include burned-in caption text when the frame sample includes non-caption text.
